(19) United States
(12) Patent Application Publication
(10) Pub. No.: US 2018/0215046 A1
(43) Pub. Date: Aug. 2, 2018

(54) IMAGE ACQUISITION SYSTEM FOR WIRE GROUP PROCESSING

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Satoshi OE, Yokkaichi, Mie (JP)

(21) Appl. No.: 15/562,963

(22) PCT Filed: Mar. 10, 2016
(86) PCT No.: PCT/JP2016/057514

§ 371 Date: Sep. 29, 2017

(30) Foreign Application Priority Data
Mar. 31, 2015 (JP) 2015-072521

(51) Int. Cl. B25J 13/08; G06T 7/00; G06T 7/73; G06T 7/11; G06T 7/174; G06T 1/00; H01B 13/012

(52) U.S. Cl. CPC B25J 13/08; G06T 7/001; G06T 7/73; G06T 7/11; G06T 2207/10028; G06T 1/0007; H01B 13/012; G06T 2207/10012; G06T 7/174

(57) ABSTRACT

An image acquisition system for wire group processing is a system for recognizing the wire group constituting the wire harness. This image acquisition system includes a first vision system (e.g. a two-dimensional vision system) that acquires first image data for recognizing the wire group constituting the wire harness in a first imaging range, and a second vision system (e.g. a three-dimensional vision system) that acquires second image data for recognizing the wire group constituting the wire harness in a second imaging range which is within a region that overlaps with the first imaging range and is smaller than the first imaging range, the second image data having a greater amount of information per unit of area than that of the first image data.

### CROSS REFERENCE TO RELATED APPLICATIONS

This application claims the priority of Japanese patent application JP2015-072521 filed on Mar. 31, 2015, the entire contents of which are incorporated herein.

### TECHNICAL FIELD

This invention relates to a technique for recognizing a wire group when manufacturing a wire harness.

### BACKGROUND ART

Patent Document 1 (JP 2014-32840A) discloses a method of manufacturing a wire harness by arranging a plurality of wires in a state based on wiring paths of a vehicle and then tying the wires on a drafting board while keeping the wires branched in a state conforming to the wiring paths.

Patent Document 2 (JP 2012-245602A) discloses a technique of using a 3D vision sensor to recognize components supplied in bulk from a component supply unit and using a 2D vision sensor to recognize the positional orientations of components placed on a temporary placement platform. Patent Document 2 also discloses a technique in which the 2D vision sensor has 3D vision sensor functionality, and the 3D vision sensor functionality is activated in the case where the positional orientation of a component placed in a specific position on the temporary placement platform cannot be recognized.

### SUMMARY

As disclosed in Patent Document 1, the wire harness is manufactured by manually tying together wires on a drafting board. It is preferable to enable such a wire harness to be automatically manufactured using a robot or the like. To that end, image recognition of a wire group constituting the wire harness is necessary.

The wires that constitute a wire harness are long, narrow products of several meters, and are furthermore irregular in shape. It is therefore necessary to recognize the wire group throughout a comparatively wide range. At the same time, for tasks such as tying wires together, partial detailed recognition is also necessary, such as recognizing the positions of wires at the centimeter or millimeter level, or recognizing positions in three dimensions.

However, a camera capable of recognizing a wide range is not suited to recognizing positions at the centimeter or millimeter level, or recognizing positions in three dimensions. By the same token, a camera capable of recognizing positions at the centimeter or millimeter level, or a camera capable of recognizing positions in three dimensions, is not suited to recognizing a wide range.

Alternating between the 3D vision sensor and the 2D vision sensor as disclosed in Patent Document 2 does not make it possible to recognize the wire group constituting the wire harness both at the overall level and at a partial detailed level.

Accordingly, it is an objective of the present system to provide a technique suited to achieving both overall recognition of a wire group constituting a wire harness, and partial detailed recognition of the wire group.

To solve the above-described problems, a first aspect is an image acquisition system for wire group processing that recognizes a wire group constituting a wire harness, the system including: a first vision system that acquires first image data for recognizing the wire group constituting the wire harness in a first imaging range; and a second vision system that acquires second image data for recognizing the wire group constituting the wire harness in a second imaging range, the second imaging range being a region overlapping with the first imaging range and smaller than the first imaging range, and the second image data having a greater information amount per unit of area than the first image data.

A second aspect is the image acquisition system for wire group processing according to the first aspect, wherein the second vision system is a three-dimensional vision system.

A third aspect is the image acquisition system for wire group processing according to the second aspect, wherein the second vision system is a system including a phase modulation-type projection light source and a stereo camera, that acquires three-dimensional point group data through active triangulation.

A fourth aspect is the image acquisition system for wire group processing according to any one of the first to third aspects, wherein the second vision system includes a camera, and the camera is attached to a robot arm of a processing robot that processes the wire group constituting the wire harness.

A fifth aspect is the image acquisition system for wire group processing according to any one of the first to fourth aspects, wherein the first vision system is a two-dimensional vision system.

According to the first aspect, the overall wire group constituting the wire harness can be suitably recognized by the first vision system. Additionally, the wire group can be partially recognized in detail in a suitable manner by the second vision system.

According to the second aspect, when partially recognizing the wire group, the wire group can be recognized three-dimensionally.

According to the third aspect, the wire group can be partially recognized in detail in a suitable manner by the second vision system.

According to the fourth aspect, when processing the wire group using an arm of a processing robot, the part of the wire group to be processed can be recognized in detail.

According to the fifth aspect, when recognizing the first imaging range that is comparatively wide using the first vision system, the processing can be carried out comparatively quickly.

### BRIEF DESCRIPTION OF DRAWINGS

FIG. 1 is a schematic diagram illustrating a wire group processing device including an image acquisition system for wire group processing according to an embodiment.

FIG. 2 is a block diagram illustrating the wire group processing device.

FIG. 3 is a flowchart illustrating an example of processing carried out by a processing control unit based on first image data and second image data from the image acquisition system.

FIG. 4 is a descriptive diagram illustrating an example of processing of a wire group by the wire group processing device.

FIG. 5 is a descriptive diagram illustrating an example of processing of a wire group by the wire group processing device.

FIG. 6 is a descriptive diagram illustrating an example of processing of a wire group by the wire group processing device.

FIG. 7 is a descriptive diagram illustrating an example of processing of a wire group by the wire group processing device.

FIG. 8 is a descriptive diagram illustrating an example of processing of a wire group by the wire group processing device.

FIG. 9 is a descriptive diagram illustrating an example of processing of a wire group by the wire group processing device.

FIG. 10 is a descriptive diagram illustrating an example of processing of a wire group by the wire group processing device.

FIG. 11 is a schematic diagram illustrating a three-dimensional vision system according to a variation.

FIG. 12 is a descriptive diagram illustrating a state in which a three-dimensional vision system is supported on a base plate.

### DESCRIPTION OF EMBODIMENTS

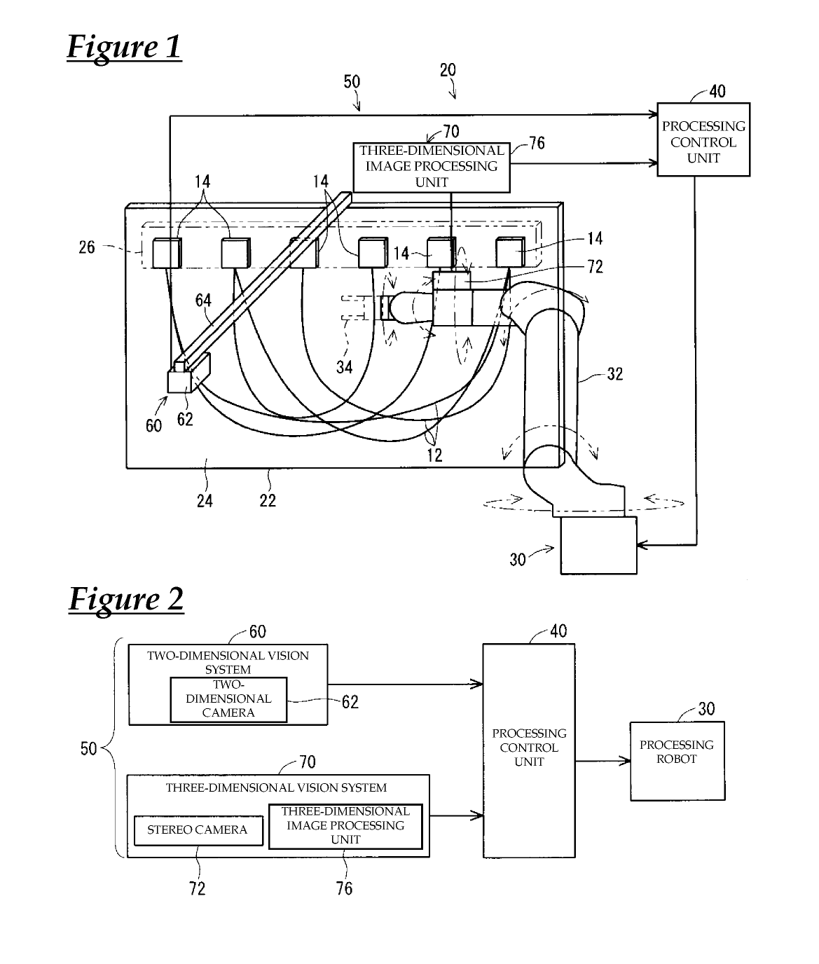

An image acquisition system for wire group processing according to an embodiment will be described hereinafter. FIG. 1 is a schematic diagram illustrating a wire group processing device 20 including an image acquisition system 50 for wire group processing, and FIG. 2 is a block diagram illustrating the wire group processing device 20.

A wire harness 10 to be processed is constituted of a plurality of wires 12 that are tied in a branching state (see FIG. 10). At the end of the branches of the wire harness 10, terminals attached to end portions of the wires 12 are inserted into and connected to connectors 14. The wire harness 10 is incorporated into a vehicle, and the connectors 14 are connected to various electrical components installed in the vehicle. The wire harness 10 therefore fulfills a role of electrically connecting the various electrical components installed in the vehicle. The wires 12 included in the wire harness 10 are tied in a branching state in a form that conforms to a layout path in the vehicle. This wire group processing device 20 carries out the task of tying the plurality of wires 12 in a branching state in a form that follows the layout path. Note that in the drawings, wires 12 following the same path are depicted with a single line. As such, in the drawings, a wire 12 depicted as a single line can actually be a bundle of a plurality of wires 12.

The wire group processing device 20 includes a wire support portion 22, a processing robot 30, a processing control unit 40, and an image acquisition system 50.

The wire support portion 22 is configured to be capable of supporting the connectors 14 at the end portions of the wires 12. In other words, the plurality of wires 12 are supported by the wire support portion 22 in a state in which the terminals at the end portions are inserted into the connectors 14. Although automatic insertion devices that automatically insert the terminals at the end portions of the plurality of wires 12 into the connectors 14 are known technology, the insertion task may be carried out by hand instead.

To go into further detail, the wire support portion 22 includes a base plate 24 and a connector support portion 26.

Here, the base plate 24 is formed having a rectangular plate shape, and is supported in a vertical orientation with respect to the gravitational direction. Preferably, a working surface of the base plate 24, which is one main surface of the base plate 24, has a uniform color different from the wires 12 so that the wires 12 on the working surface can easily undergo image recognition using the base plate 24 as a background. However, it is not absolutely necessary to provide the base plate 24.

The connector support portion 26 is configured to be capable of supporting a plurality of the connectors 14 in set positions. For example, a long, narrow member in which a plurality of connector setting recesses are formed at intervals along the direction in which the long, narrow member extends can be used as the connector support portion 26. Here, the connector support portion 26 is fixed to an upper position of the working surface of the base plate 24. The connector setting recesses are formed having recessed shapes into which the connectors 14 can be fitted and set. The connectors 14 are fitted into the connector setting recesses and supported in set positions in orientations such that the end portions on the sides on which the wires 12 extend face downward. The wires 12 extending from the connectors 14 are installed so as to hang downward from the connectors 14 supported in set positions by the connector support portion 26. Terminals on both end portions of each of wire 12 are inserted into and connected to connectors 14 supported at different positions, and thus the wire 12 therebetween is supported so as to hang downward in a U shape between the two connectors 14. Preferably, the wires 12 are present within a region in which the working surface of the base plate 24 is present.

The processing robot 30 is a typical industrial robot, and a typical vertically articulated robot is illustrated in FIG. 1. The processing robot 30 includes a robot arm 32, and a processing task portion 34 provided on a leading end portion of the robot arm 32. The robot arm 32 is constituted of a plurality of arm portions linked together by joint mechanisms so as to be capable of rotating around axes, and the processing task portion 34 is provided on a leading end portion thereof. By operating the robot arm 32, the processing robot 30 can cause the processing task portion 34 to move to a desired position on the working surface of the base plate 24 in a desired orientation.

The processing task portion 34 is a portion that processes a group of the wires 12. Here, collecting predetermined positions of the wires 12 in the extension direction thereof into set positions (bundling intermediate positions of the plurality of wires 12 in the extension direction thereof), tying the plurality of wires 12 (for example, wrapping the wires 12 in adhesive tape), and so on are assumed as the processing carried out on the group of the wires 12.

To carry out the former type of processing, a known robot hand capable of gripping and moving a wire 12 to a set position, gripping a plurality of wires 12 so as to gather those wires 12 together, and so on can be used as the processing task portion 34. To carry out the latter type of processing, a known automatic tape winding machine can be used as the processing task portion 34.

In order to carry out multiple types of processing tasks, a plurality of the processing robots 30 may be provided. Alternatively, a plurality of the processing task portions 34 may be attached to the leading end portion of the robot arm 32 so as to be capable of moving relative to each other.

Rather than a vertically articulated robot, the processing robot may be a Cartesian coordinate robot or the like. Additionally, the processing task portion may be changed as appropriate in accordance with the task to be carried out on the group of the wires 12.

The processing control unit 40 is constituted of a typical computer including a CPU, RAM, ROM, an input circuit unit, and so on. The ROM is constituted of rewritable non-volatile semiconductor memory such as flash memory, and stores a processing target region based on image data acquired by the image acquisition system 50, a sequence for determining the position and orientation of a processing target (the group of the wires 12), a program in which processing sequences and processing details for the group of the wires 12 are written, and so on. By executing the program stored in the ROM, the CPU executes processing for supplying overall instructions to the processing robot 30 in order to carry out overall processing on the group of the wires 12 on the basis of the image data acquired by the image acquisition system 50.

The image acquisition system 50 is a system for acquiring image data for recognizing the group of the wires 12 constituting the above-described wire harness 10, and includes a two-dimensional vision system 60 serving as a first vision system and a three-dimensional vision system 70 serving as a second vision system.

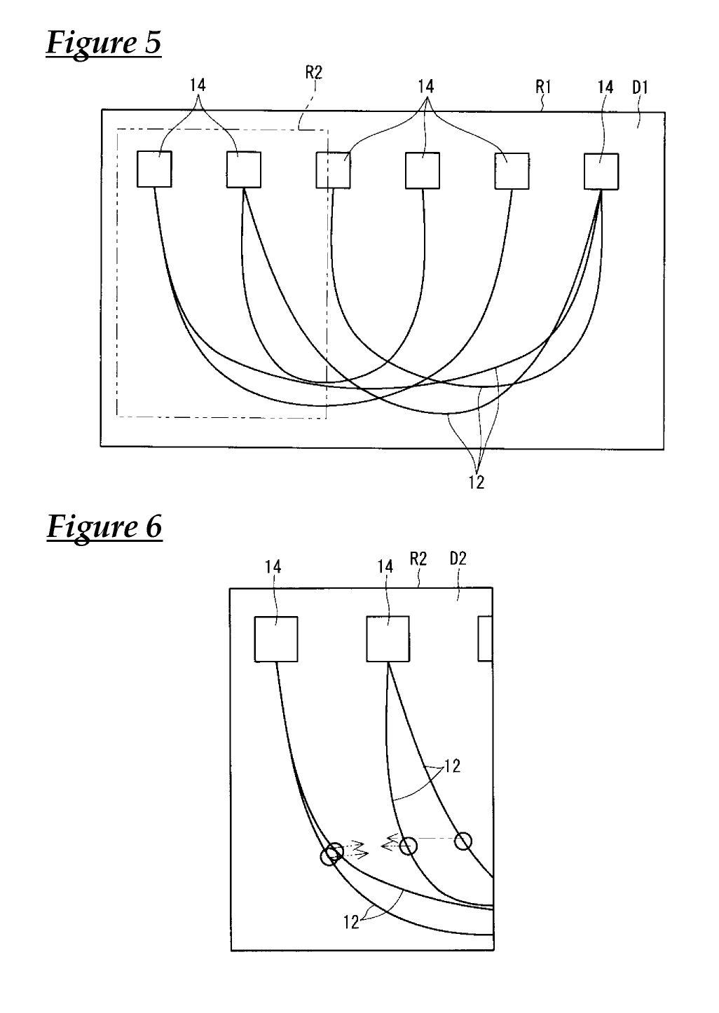

The two-dimensional vision system 60 is configured to be capable of acquiring first image data D1 for recognizing a first imaging range R1 of the group of the wires 12 constituting the wire harness 10 (see FIG. 5).

That is, the two-dimensional vision system 60 includes a two-dimensional camera 62. The two-dimensional camera 62 is supported by a camera support member 64 in a position distanced from the working surface of the base plate 24, and is installed so as to be capable of capturing an image of the entirety of a region in which the group of the wires 12 is assumed to be arranged on the working surface of the base plate 24 as the first imaging range R1. The first image data D1 obtained by the two-dimensional vision system 60 is supplied to the processing control unit 40.

Note that the two-dimensional vision system 60 may instead include a plurality of two-dimensional cameras, each capable of capturing an image of part of the first imaging range R1, and the first image data D1 of the first imaging range R1 may then be obtained by connecting the images captured by the plurality of two-dimensional cameras. Alternatively, the two-dimensional vision system 60 may include a single two-dimensional camera capable of capturing an image of part of the first imaging range R1 as well as a movement mechanism unit capable of moving the two-dimensional camera. A plurality of images capturing part of the first imaging range R1 may be obtained by moving the two-dimensional camera, and the first image data D1 of the first imaging range R1 may then be obtained by stitching that plurality of images together. Furthermore, a three-dimensional vision system that acquires three-dimensional image data may be used as the first vision system.

The three-dimensional vision system 70 is configured to be capable of acquiring second image data D2 of the group of the wires 12 constituting the wire harness 10, the second image data D2 being acquired in a second imaging range R2 that overlaps with the first imaging range R1 and is smaller than the first imaging range R1, and the second image data D2 having a greater information amount per unit of area than the first image data D1 (see FIGS. 5 and 6).

Here, the three-dimensional vision system 70 includes a stereo camera 72 including a plurality of cameras, and a three-dimensional image processing unit 76. The imaging range of the stereo camera 72 is smaller than the above-described first imaging range R1. The stereo camera 72 is attached to the leading end portion of the robot arm 32 of the processing robot 30, in a position that does not interfere with the processing task portion 34. Accordingly, the stereo camera 72 can capture an image of the group of the wires 12 in the second imaging range R2 that overlaps with the first imaging range R1 and is smaller than the first imaging range R1.

Note that the stereo camera 72 may be installed so as to be movable above the base plate 24 by a movement mechanism unit separate from the processing robot 30.

The stereo camera 72 captures images of the second imaging range R2 from different directions, and outputs image data obtained as a result to the three-dimensional image processing unit 76. The three-dimensional image processing unit 76 is constituted of a typical computer including a CPU, RAM, ROM, an input circuit unit, and so on. The ROM is constituted of rewritable non-volatile semiconductor memory such as flash memory, and stores a program in which is written a sequence for generating three-dimensional data (point group data) of the group of the wires 12, serving as a processing target, as the second image data D2, on the basis of the plurality of pieces of image data of the second imaging range R2 captured from different directions. The second image data D2 obtained by the three-dimensional image processing unit 76 is then outputted to the processing control unit 40. Various types of known processes that generate three-dimensional point group data according to the principle of triangulation on the basis of a plurality of pieces of image data from different positions can be employed as the process for creating three-dimensional data on the basis of the images from the stereo camera 72. Note that the stereo camera 72 does not absolutely require a plurality of cameras, and may instead obtain a plurality of pieces of image data from different directions by moving a single camera.

The second image data D2, which corresponds to the aforementioned three-dimensional data, is data having a greater information amount per unit of area than the above-described first image data D1. Here, the “information amount per unit of area” refers to an amount of information for expressing the group of the wires 12 in the case where the group of the wires 12 supported by the wire support portion 22 is observed from a set direction (here, the case where the group of the wires 12 is observed from above the base plate 24). Here, for example, the following two cases are considered. The first case is a case in which the first vision system acquires two-dimensional image data as the first image data D1 and the second vision system acquires three-dimensional image data as the second image data D2, as described in the present embodiment. The second case is a case in which the first vision system acquires two-dimensional image data or three-dimensional image data as the first image data D1 and the second vision system acquires two-dimensional image data or three-dimensional image data, of the same number of dimensions as the first image data D1, as the second image data D2, but with the latter second image data D2 having a higher resolution than the former first image data D1.

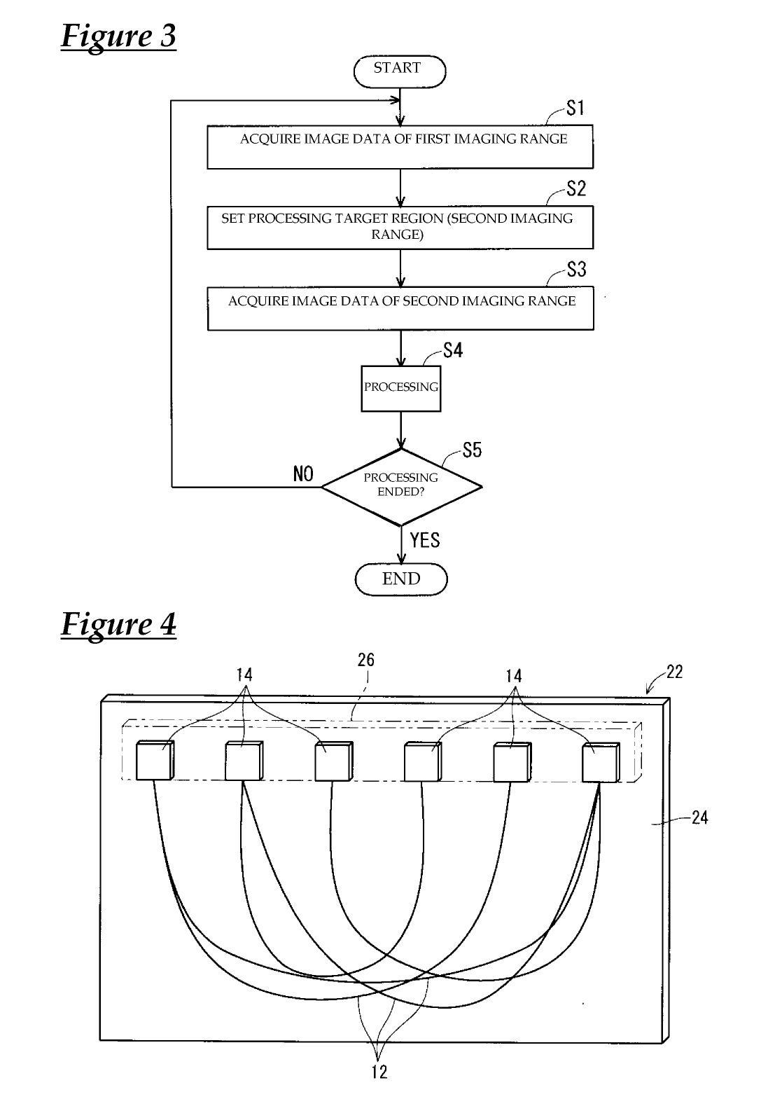

FIG. 3 is a flowchart illustrating an example of processing carried out by the processing control unit 40 on the basis of the first image data D1 and the second image data D2 from the image acquisition system 50.

First, in step S1, the processing control unit 40 acquires the first image data D1 of the first imaging range R1 including the overall group of the wires 12 using the two-dimensional vision system 60.

Next, in step S2, the processing control unit 40 recognizes the position and so on of the group of the wires 12 by carrying out image processing such as edge extraction processing on the first image data D1, and determines a processing target region (the second imaging range R2). The position of the processing target region determined at this time may be an approximate position, and thus a high degree of precision is not necessary when determining this region.

Next, in step S3, the processing control unit 40 acquires the second image data D2 of the second imaging range R2 using the three-dimensional vision system 70.

Next, in step S4, the processing control unit 40 recognizes the positions, orientations, and so on of processing targets in the second imaging range R2 on the basis of the second image data D2, and supplies processing instructions to the processing robot 30 on the basis of result of that recognition. At this time, the positions, orientations, and so on of the processing targets can be recognized on the basis of the second image data D2, which has a greater information amount, and thus processing instructions specifying precise positions and so on can be made to the processing robot 30. As a result, the processing robot 30 carries out processing on the group of the wires 12.

Next, in step S5, the processing control unit 40 determines whether or not all processing defined in the program has ended. In the case where the processing has not ended (that is, in the case where processing is defined for the next separate location), the sequence returns to step Si and the process from step Si on is carried out again.

In the case where the process from step Si is executed again, the processing control unit 40 acquires the first image data D1 of the first imaging range R1 through the two-dimensional vision system 60 again. In other words, because the wires 12 are long, narrow members having irregular shapes, there is a risk that if the processing for the group of the wires 12 is carried out at one location, the positions and orientations of other parts will change as a result. Thus when processing is carried out on the next separate location, the process is carried out again from step S1 and the processing position of the next separate location is specified. This makes it possible to carry out the appropriate processing in sequence in accordance with changes in the positions of the wires 12, which are long, narrow members having irregular shapes.

In the case where it is determined in step S5 that the processing has ended, the process ends.

An example of processing the group of the wires 12 using the wire group processing device 20 will be described in detail hereinafter.

First, in an initial state, the connectors 14 connected to the end portions of the group of the wires 12 are supported by the connector support portion 26 of the wire support portion 22, as illustrated in FIG. 4. The wires 12 between respective connectors 14 hang down in U shapes above the base plate 24.

In this state, the first image data D1 of the first imaging range R1 including the group of the wires 12 is obtained by the two-dimensional vision system 60, as illustrated in FIG. 5. The obtained first image data D1 includes the group of the wires 12 hanging down in U shapes, with the connectors 14 serving as starting positions thereof.

Here, it is assumed that a task of tying the wires 12 extending from the first connector 14 from the left and the second connector 14 from the left at a position distanced from those connectors 14 by a set dimension (that is, a task of forming a branch part) is defined as the first processing carried out on the group of the wires 12. The connectors 14 are supported by the connector support portion 26, and thus can be treated as being in known positions.

In this case, the wires 12 are recognized by carrying out image processing such as edge extraction processing on the first image data D1, and the second imaging range R2 may be determined so as to include the parts of the wires 12 extending from the first connector 14 from the left and the second connector 14 from the left that are within the set dimension. As a result, a processing target region (the second imaging range R2) can be set within the first imaging range R1. Note that the recognition processing such as the edge extraction processing carried out on the first image data D1 may be implemented by a two-dimensional image processing unit provided outside of the processing control unit 40 and between the processing control unit 40 and the two-dimensional camera 62. In this case, a configuration including the two-dimensional camera 62 and the two-dimensional image processing unit may be taken as the two-dimensional vision system.

After this, the stereo camera 72 is moved by the robot arm 32 of the processing robot 30, and the stereo camera 72 is arranged in a position where the second imaging range R2 can be captured. The second image data D2 of the second imaging range R2 is then acquired by the three-dimensional vision system 70 including the stereo camera 72, as illustrated in FIG. 6.

Then, on the basis of the second image data D2, the paths of the wires 12 are followed and positions distanced from the connectors 14 by the set dimension (positions indicated by the circles in FIG. 6) are specified, using the positions of the connectors 14, which are known positions, as a reference. Each of these positions corresponds to a location to be bundled together as a branching point. Because the second image data D2 is three-dimensional data, the positions of the wires 12 can be specified so as to include height positions of the wires 12 from the base plate 24 as well. An instruction to gather the positions of the wires 12 into a single location is then supplied to the processing robot 30. In this case, individual robot hands may gather the positions of corresponding wires 12 into the single location. Alternatively, a plurality of wires 12 may be gathered into the single location by a single robot hand. Even in the latter case, the positions of corresponding wires 12 can be gathered into the single location by adjusting the positions at which the connectors 14 are supported and gathering the wires 12 together while pulling the wires 12 from the connectors 14 such that the positions of the wires 12 are at a single location.

After this, the wires 12 extending from the aforementioned locations where the wires 12 are bundled together are tied. In other words, because the position where the above-described wires 12 are bundled together at a single location is a known position moved to by the robot hand, the parts extending from that position to the connectors 14 and 14, and the parts extending downward therefrom, are tied. The tying task can be carried out by an automatic tape winding machine or the like attached to the robot arm 32, as described above.

When carrying out this tying task, the positions and so on of the wires 12 are different from when the overall image was captured, and thus it is preferable to acquire the second image data D2 using the three-dimensional vision system 70 again and specify the processing positions and the like using that second image data D2 again.

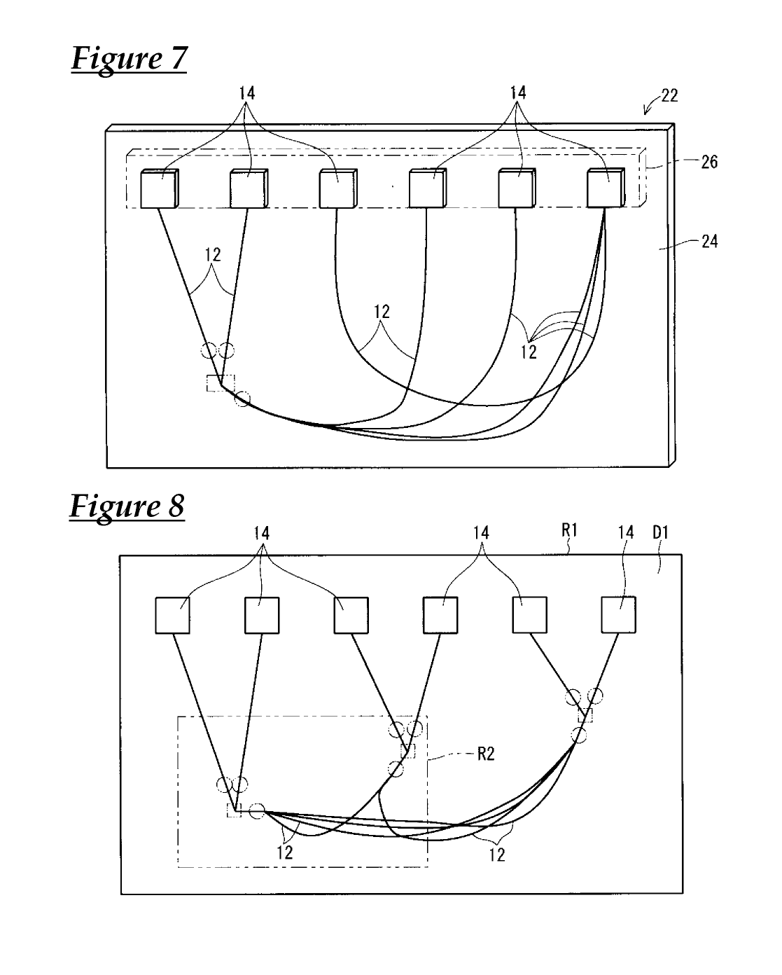

The state following this processing is as illustrated in FIG. 7. In FIG. 7, the branching point is indicated by the double-dot-dash line quadrangle, and the tied parts are indicated by the double-dot-dot-dash line circles.

Next, the plurality of wires 12 extending from the remaining connectors 14 are also tied, in the same manner as described above. Here, the plurality of wires 12 extending from the third connector 14 and the fourth connector 14 from the left are tied at a predetermined position, and the plurality of wires 12 extending from the fifth connector 14 and the sixth connector 14 from the left are tied at a predetermined position.

As a result, the plurality of wires 12 extending from the connectors 14 are tied at branching locations near those corresponding connectors 14, as illustrated in FIG. 8.

Next, the plurality of wires 12 are tied between the branching locations obtained up to this point. Here, a task of tying a plurality of wires 12 at trunks where many pluralities of the wires 12 are bundled together is carried out.

Here as well, the first image data D1 is first acquired using the two-dimensional vision system 60, and the wires 12 are recognized by carrying out image processing such as edge extraction processing on the first image data D1. Then, in accordance with the next processing details (for example, between which of the branching locations the wires 12 are to be tied), the second imaging range R2 is set so as to include the parts of the wires 12, between some of the plurality of branching locations or extending from any one of the branching locations, that are present within the set dimension.

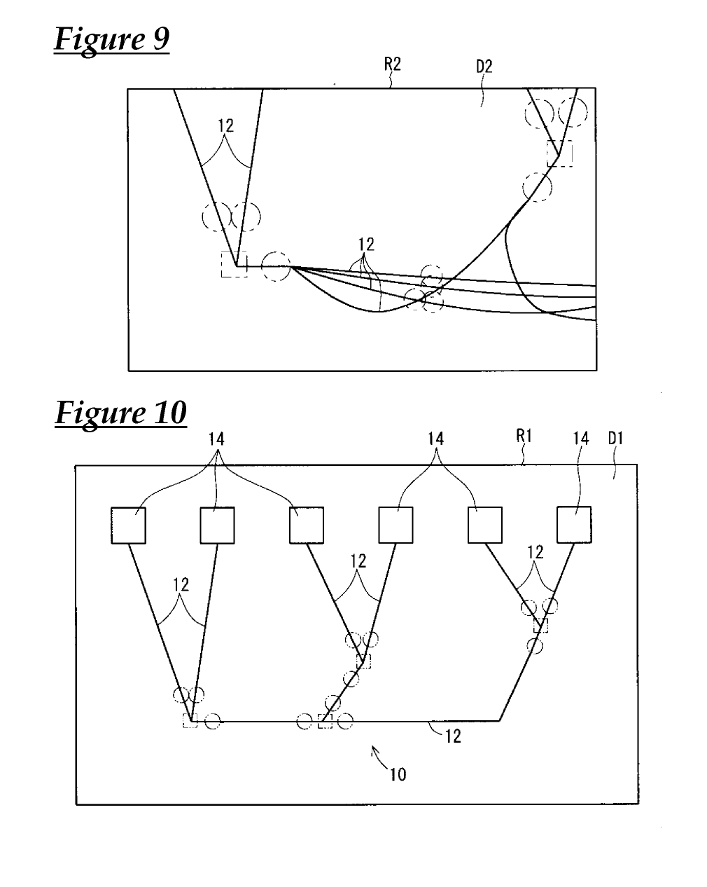

After this, the stereo camera 72 is moved by the robot arm 32 of the processing robot 30, and the stereo camera 72 is arranged in a position where the second imaging range R2 can be captured. The second image data D2 of the second imaging range R2 is then acquired by the three-dimensional vision system 70 including the stereo camera 72, as illustrated in FIG. 9.

Then, on the basis of the second image data D2, and using the branching positions as a reference (the branching positions themselves are in known positions or are specified as positions in the second image data D2 where the wires 12 gather from a plurality of directions), the paths of the wires 12 are followed and positions distanced from the branching positions in any direction by the set dimension (the positions indicated by circles in FIG. 9) are specified. Each position is a location in the trunk that is to be bundled together. An instruction to gather the parts of the wires 12 at those positions into a single location is then supplied to the processing robot 30. After this, the wires 12 are tied at areas in the periphery of the aforementioned positions where the wires 12 are bundled together.

Once the plurality of wires 12 are bundled together between respective branching positions, the plurality of wires 12 are tied together while branching at a plurality of positions, as indicated by the first image data D1 of the first imaging range R1 in FIG. 10. The wire harness 10 can be manufactured as a result.

Note that outer components such as clamp components for fixing the wire harness 10 to the vehicle, protectors and convoluted tubes for protecting the wire harness 10, and so on may be attached to the wire harness 10 as necessary by the processing robot 30 or manually.

According to the image acquisition system 50 for wire group processing configured as described above, the first image data D1, in which an image of the group of the wires 12 constituting the wire harness 10 is captured, can be obtained by the two-dimensional vision system 60, which corresponds to the first vision system. This makes it possible to implement a configuration suitable for ascertaining the general shape of the wire harness 10 and the approximate positions and so on of the processing targets when carrying out processing using the processing robot 30. Additionally, the second image data D2, which has a greater information amount per unit of area, can be obtained by the three-dimensional vision system 70, which corresponds to the second vision system. Accordingly, the group of the wires 12 can be partially recognized in detail as appropriate when carrying out processing using the processing robot 30. For example, the group of the wires 12 can be processed by the processing robot 30 having recognized the positions of the wires 12 at the centimeter or millimeter level or having recognized the positions of the wires 12 in three dimensions.

In particular, the three-dimensional vision system 70 is used as the second vision system, and thus the group of the wires 12 can be processed having recognized the wires 12 in three dimensions. Accordingly, more appropriate processing can be carried out by the processing robot 30.

Additionally, the stereo camera 72 of the three-dimensional vision system 70 is attached to the leading end portion of the robot arm 32, and thus an image of the second imaging range R2 can be captured in a state where the leading end portion of the robot arm 32 is close to the position to be processed. The position to be processed present in the second imaging range R2 can be processed immediately thereafter. This makes it possible to carry out the tasks efficiently. Additionally, an image of the processing target can be captured even while the processing task portion 34 attached to the leading end portion of the robot arm 32 is carrying out tasks.

Additionally, the first vision system is the two-dimensional vision system 60, and thus in the case where an image is captured in the first imaging range R1, which is a comparatively wide range, or in other words, an image is captured of the overall group of the wires 12 and the recognition processing is carried out thereon, the processing can be carried out comparatively quickly.

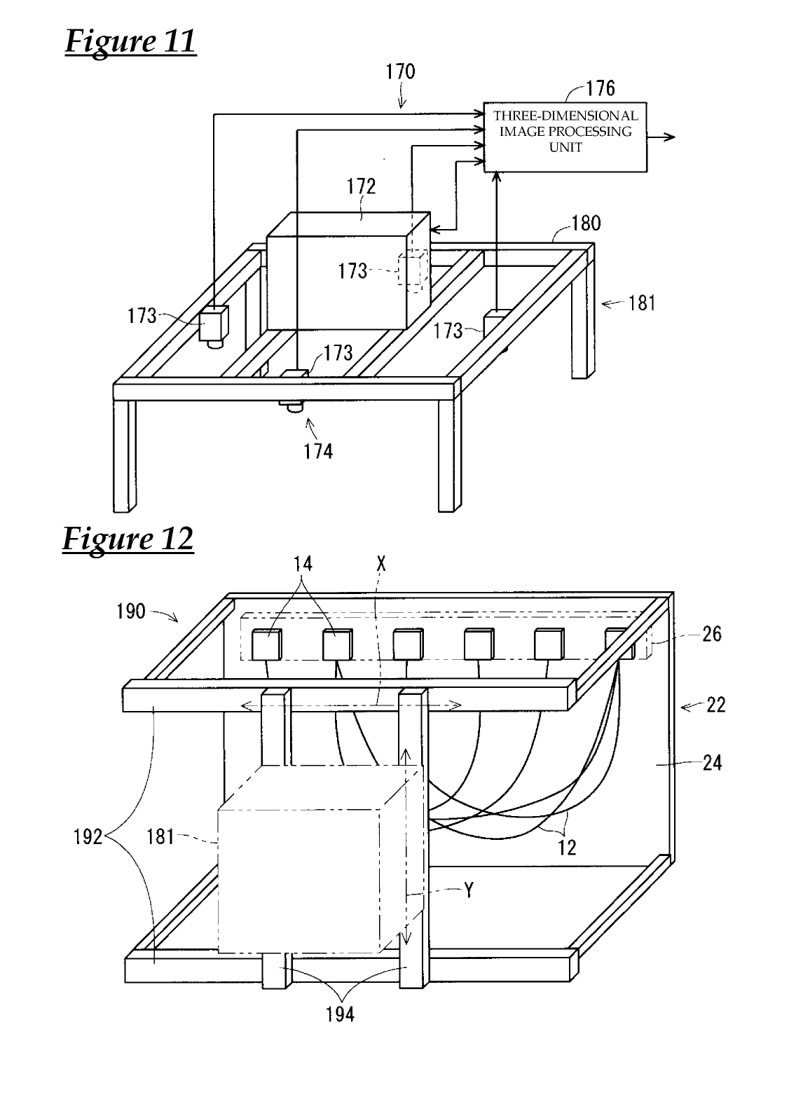

A three-dimensional vision system 170 including a phase modulation-type projection light source 172, a stereo camera 174, and a three-dimensional image processing unit 176 may be used as the second vision system in the above-described embodiment, as illustrated in FIGS. 11 and 12.

The phase modulation-type projection light source 172 is configured to be capable of projecting a stripe pattern onto a target object while varying a phase. The stereo camera 174 includes a plurality of cameras 173 arranged at different positions.

In a quadrangular frame 180 arranged above the base plate 24, the phase modulation-type projection light source 172 is arranged in the center of the frame 180, and projects projection light onto the group of the wires 12 above the base plate 24. The plurality of cameras 173 are arranged in four positions with respect to the phase modulation-type projection light source 172, that is, in a center position of each side of the frame 180, and are configured to be capable of capturing an image of the group of the wires 12, on which the projection light is projected above the base plate 24, from mutually different directions.

The plurality of cameras 173 capture an image of the target object on which the stripe pattern is projected while varying the phase, and supply resulting captured image data to the three-dimensional image processing unit 176. Accordingly, on the basis of that captured image data, the three-dimensional image processing unit 176 generates three-dimensional identification data (point group data) of the group of the wires 12 as the second image data D2 through active triangulation.

An image capturing unit 181 that incorporates the phase modulation-type projection light source 172 and the stereo camera 174 into the frame 180 is supported above the base plate 24 by a movement mechanism unit 190 including a first direction movement mechanism unit 192 (see an arrow X) and a second direction movement mechanism unit 194 (see an arrow Y). The first direction movement mechanism unit 192 and the second direction movement mechanism unit 194 are each constituted of a linear driving mechanism including a linear motor, a screw shaft, a motor that rotationally drives the screw shaft, a nut part threaded onto the screw shaft, and so on, a linear actuator such as an air cylinder or a hydraulic cylinder, or the like, and are arranged in a positional relationship such that a first direction X and a second direction Y, which are the movement driving directions of the respective movement mechanism units, are orthogonal to each other. The phase modulation-type projection light source 172 and the stereo camera 174 can be moved horizontally and vertically above the base plate 24 while maintaining the relative positional relationship thereof by driving the first direction movement mechanism unit 192 and the second direction movement mechanism unit 194. As a result, the image capturing unit 181 can capture an image of a desired region of the group of the wires 12 (that is, the second imaging range R2).

Note that the processing robot 30 and the two-dimensional vision system 60 may be arranged in a position, between the image capturing unit 181 and the base plate 24, that does not interfere with the image capturing unit 181 and the like. Additionally, the image capturing unit 181 may be attached to the leading end portion of the robot arm 32.

According to this variation, the group of the wires 12 can be partially recognized in detail in a more suitable manner.

Additionally, in the above-described embodiment, in the case where branching positions and the like produced by tying the wires 12 are to be recognized after the wires 12 are tied, image data of before and after the tying process may be obtained by the two-dimensional vision system 60 or the three-dimensional vision system 70, and locations of change in the image data (an exclusive OR between pixels or point groups in the two pieces of image data) may be found. This makes it possible to narrow down the regions including locations of change produced by the processing and recognize the branching positions and so on after the tying, which in turn makes it possible to carry out the process more quickly. This process can also be used as a process for ensuring that processing is not carried out on locations aside from those to be processed (that is, for ensuring that there is no movement).

While the system has been described in detail above, the foregoing descriptions are in all ways exemplary, and the invention is not intended to be limited thereto. It is to be understood that countless variations not described here can be conceived of without departing from the scope of the invention.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### REFERENCE SIGNS LIST

D1 First image data
D2 Second image data
R1 First imaging range
R2 Second imaging range
10 Wire harness
12 Wire
14 Connector
20 Wire group processing device
22 Wire support portion
26 Connector support portion
30 Processing robot
50 Image acquisition system
60 Two-dimensional vision system
62 Two-dimensional camera
70, 170 Three-dimensional vision system
72, 174 Stereo camera
76, 176 Three-dimensional image processing unit
172 Phase modulation-type projection light source
173 Camera

1. An image acquisition system for wire group processing that recognizes a wire group constituting a wire harness, the system comprising:
a first vision system that acquires first image data for recognizing the wire group constituting the wire harness in a first imaging range; and
a second vision system that acquires second image data for recognizing the wire group constituting the wire harness in a second imaging range, the second imaging range being a region overlapping with the first imaging range and smaller than the first imaging range, and the second image data having a greater information amount per unit of area than the first image data.

2. The image acquisition system for wire group processing according to claim 1,
wherein the second vision system is a three-dimensional vision system.

3. The image acquisition system for wire group processing according to claim 2,
wherein the second vision system is a system including a phase modulation-type projection light source and a stereo camera, that acquires three-dimensional point group data through active triangulation.

4. The image acquisition system for wire group processing according to claim 1,
wherein the second vision system includes a camera, and the camera is attached to a robot arm of a processing robot that processes the wire group constituting the wire harness.

5. The image acquisition system for wire group processing according to claim 1,
wherein the first vision system is a two-dimensional vision system.
